(19) United States
(12) Patent Application Publication
(10) Pub. No.: US 2025/0206674 A1
(43) Pub. Date: Jun. 26, 2025

(54) Ceramic Sintered Body Made of a Sialon Material, Raw Material Mixture Thereof, and Manufacture Thereof

(71) Applicant: CeramTec GmbH, Plochingen (DE)

(72) Inventors: Sandra Nemrava, Deizisau (DE); Volker Dietrich, Lampertheim (DE); Moritz Stahl, Nürtingen (DE)

(21) Appl. No.: 18/849,134

(22) PCT Filed: Mar. 7, 2023
(86) PCT No.: PCT/EP2023/055769

§ 371 Date: Sep. 20, 2024

(30) Foreign Application Priority Data
Mar. 21, 2022 (EP) 22163349.8

(51) Int. Cl. C04B 35/587; C04B 35/593; C04B 35/626; C04B 35/638; C04B 35/645

(52) U.S. Cl. CPC C04B 35/587; C04B 35/593; C04B 35/6261; C04B 35/62625; C04B 35/638; C04B 35/645; C04B 2235/3222; C04B 2235/3224; C04B 2235/3869; C04B 2235/3873; C04B 2235/5436; C04B 2235/5445; C04B 2235/656; C04B 2235/658; C04B 2235/764

(57) ABSTRACT

It is provided a sintered body on the basis of β-sialon and 15R-sialon, which as a cutting material has a high cutting performance as compared to workpieces made of nickel-based alloy or Heat Resistant Super Alloys. For this purpose, a ceramic sintered body is shown, which includes a sialon phase and an amorphous or semi-crystalline grain boundary phase. The sialon phase includes a proportion of 20-80 wt-% of 15R-sialon polytypoid. The amorphous or semi-crystalline grain boundary phase possibly includes an Yb—Al garnet and constitutes up to 15 wt-% of the entire sintered body. The sintered body is manufactured from an inorganic raw material mixture which includes 40 to 57 wt-% of Si₃N₄; 40 to 55 wt-% of a mixture of AlN and Al₂O₃, wherein the ratio of Al₂O₃ to AlN lies in the range of 1-1.5:1, and 3 to 5 wt-% of Yb₂O₃ as sintering aid.

### CROSS-REFERENCE TO RELATED APPLICATIONS

This application is the United States national phase of International Patent Application No. PCT/EP2023/055769 filed Mar. 7, 2023, and claims priority to European Patent Application No. 22163349.8 filed Mar. 21, 2022, the disclosures of each of which are hereby incorporated by reference in their entireties.

### BACKGROUND

### Technical Field

The subject-matter of this disclosure is a sialon material whose sialon phase comprises β-sialon and 15R-sialon polytypoid. The sialon material furthermore comprises an amorphous or semi-crystalline grain boundary phase.

### Technical Considerations

Sintered sialons are known, chemically stable materials with a high mechanical strength over a wide temperature range. Sialons therefore are used as heat-resistant parts in machines. The high mechanical strength leads to a low wear in abrasion-intensive processes. Sialons therefore are widely used as cutting agents in cutting tools.

Sintered bodies made of α/β-sialon, in particular for use as cutting tool, e.g., as cutting agent, are known from the prior art. The mixtures of α-sialon and β-sialon provide for the manufacture of sintered bodies which on the one hand have a high hardness due to the granular α-sialon and on the other hand also have a good toughness due to the needle-shaped β-sialon grains.

### SUMMARY

The object of the present disclosure consists in providing a sialon sintered body which has a high chemical resistance, a high hardness and a good fracture toughness. The sintered body chiefly will be used in the machining treatment of nickel-based alloys or Heat Resistant Super Alloys (HRSA). There will also be provided a method for manufacturing a sialon sintered body and the underlying inorganic raw material mixture.

The object is achieved by an inorganic raw material mixture as described herein, a sialon sintered body as described herein and a method as described herein. The subordinate claims represent preferred and non-limiting embodiments. Further preferred and non-limiting embodiments will be described below. Embodiments can be freely combined with each other.

### DETAILED DESCRIPTION

All indicated percentages, unless indicated otherwise, refer to the weight (wt-%).

All indications in mol-%, unless indicated otherwise, refer to the total mixture.

All constituents of the sialon sintered body and also of the inorganic raw material mixture can include impurities. The purity of the starting materials is at least ≥97%, i.e., each starting material can include up to 3 wt-% of impurities (based on the total amount of the respective starting material). Preferably, the purity of the starting materials is ≥99%, i.e., up to 1 wt-% of impurities (based on the total amount of the respective starting material) are possible, particularly preferably the purity is ≥99.7%, i.e., up to 0.3 wt-% of impurities (based on the total amount of the respective starting material) are possible. In the ideal case, the purity of the starting materials is ≥99.9%, i.e., almost no impurities are present (up to 0.1 wt-%).

Preferably, the impurities are foreign metals in amounts of each less than 1000 ppm. In a preferred and non-limiting embodiment, Fe ions are contained in the range between 10 and 1000 ppm, preferably between 10 and 500 ppm, particularly preferably between 10 and 100 ppm. A lower Fe content leads to disproportionately high raw material and manufacturing process costs. A higher Fe content leads to the formation of iron silicide, which negatively impairs the fracture toughness of the sintered body. The contents of foreign metals are determined by means of X-ray fluorescence analysis.

Furthermore, the nitridic constituents of the raw material mixtures can include oxygen in amounts of less than 1.5 wt-%, preferably less than 1 wt-%, particularly preferably less than 0.7 wt-%, based on the total amount of the respective starting substance.

The grain sizes of the constituents of the sialon in the sintered molded body are determined by means of SEM images. The maximum needle length, i.e., the maximum expansion of the grains, should not exceed 100 μm. The determination of the composition of the sialon sintered body is effected by means of conventional X-ray analysis methods, for example XRD (DIN EN 13925-1 (2003 July) and DIN 13925-2 (2003 July)). Chemical analyses of the metallic constituents of the sintered body according to the present disclosure are effected by energy-dispersive X-ray analysis (ISO 15632; DIN EN 1071-4) and X-ray fluorescence analysis (RFA; DIN 51001 (2003 August), DIN 51418-1 (2010 May), DIN 51418-2 (2015 March)). The oxygen content is determined by means of hot gas extraction (ASTM E 1409:2013).

Sialons typically are produced by sintering a powdery mixture and chiefly consist of silicon nitride, aluminum oxide and further inorganic starting materials, such as sintering aids. The sintered body, i.e., the material, the sintered body made of the starting materials, comprises a sialon phase and an amorphous or at least semi-crystalline grain boundary phase. The sialon phase comprises β (beta)-sialon (Si_{6-Z}Al_{Z}O_{Z}N_{8-Z}, wherein 0<Z≤4.2) and 15R-sialon polytypoid (SiAl₄O₂N₄). The proportion of 15R-sialon polytypoid is 20-80 wt-%, preferably 30-70 wt-%, particularly preferably 40-60 wt-%, based on the total weight of the sialon phase. The proportion of β-sialon preferably is at least 10 wt-%, particularly preferably at least 35 wt-%. What is particularly preferred is a proportion of β-sialon of 40 wt-%. The proportion of β-sialon maximally is 80 wt-%.

The proportion of 15R-polytypoid leads to a sintered body which has a high chemical inertness, i.e., chemical reactions with the or on the sintered body are avoided by a high proportion of 15R-polytypoid. However, a high proportion of 15R-polytypoid leads to a high brittleness of the sintered body. In a range of 40 to 60 wt-% of 15R an optimum ratio of chemical inertness to fracture toughness of the sintered body can be obtained.

The detection limit in the X-ray analysis method for determining the composition of the sialon phase and for determining the individual sialons present in the sintered body lies at about 5 wt-%. Up to 10 wt-%, preferably up to 5 wt-% of further sialons, preferably selected from the list comprising α (alpha)-, 12H-, 21R- and/or 27R-sialon can be contained in the sialon phase.

The sintered body consists of the sialon phase for ≥80 wt-%, preferably for ≥85 wt-% and of the amorphous or at least semi-crystalline grain boundary phase for up to 20 wt-%, preferably for up to 15 wt-%, based on the total weight of the sintered body. Particularly preferably, the sintered body consists of the sialon phase for ≥90 wt-%.

Preferably, the proportion of grain boundary phase in the total weight of the sintered body is ≤12 wt-%, particularly preferably ≤10 wt-%. In a preferred and non-limiting embodiment, the sintered body consists of the sialon phase and of the grain boundary phase, i.e. the sum of the proportions of the sialon phase and of the grain boundary phase amounts to 100 wt-%. To be able to manufacture a sintered body as dense as possible, e.g., sintering aids are added as additives. The amount of the added additives influences the amount of grain boundary phase. In a preferred and non-limiting embodiment, the proportion of grain boundary phase is at least 5 wt-%.

The sintered body according to the present disclosure is obtained by heat treatment, the sintering, of a starting substance mixture. This starting substance mixture comprises an inorganic raw material mixture and organic constituents. An inorganic raw material mixture for producing the sialons comprises the constituents Si₃N₄, AlN, Al₂O₃ and sintering aids.

For producing the sintered body according to the present disclosure an inorganic raw material mixture is proposed, to which Yb₂O₃ is added as sintering aid.

The use of Yb₂O₃ results in a sintered body which has a high fracture toughness. As a result, the sintered body according to the present disclosure is very well suited as a cutting agent for the machining treatment of metallic workpiece materials. The high fracture toughness leads to an increased stability of the cutting edge. Thus, the sintered body withstands the loads during machining even at high cutting speeds, increased feed rate and/or greater cutting depth, also in an interrupted cut.

The sintered body according to the present disclosure, the sialon, is obtained from an inorganic raw material mixture which comprises the following constituents:
40-57 wt-% of Si₃N₄
40-55 wt-% of a mixture of AlN and Al₂O₃, wherein the ratio of Al₂O₃ to AlN lies in the range of 1-1.5:1, preferably 1-1.25:1, particularly preferably 1-1.2:1, and
3-5 wt-% of Yb₂O₃ as sintering aid.

In a preferred and non-limiting embodiment, the sum of the inorganic constituents is 100 wt-%, and the inorganic raw material mixture merely consists of the constituents Si₃N₄, AlN, Al₂O₃ and Yb₂O₃ as sintering aids.

The inorganic raw material mixture comprises all inorganic constituents which are used for manufacturing the sintered body according to the present disclosure. To manufacture the sintered body, further organic constituents are added, such as dispersing agents, pressing aids and binders, which are burnt completely during the heat treatment, debindering and sintering. These organic constituents preferably contain no metallic components. In a preferred and non-limiting embodiment, ammonium salts are used instead of sodium salts of the organic constituents.

In a preferred and non-limiting embodiment, the inorganic raw material mixture according to the invention comprises
45-54.5 wt-% of Si₃N₄,
42-50 wt-% of a mixture of AlN and Al₂O₃, wherein the ratio of Al₂O₃ to AlN lies in the range of 1-1.5:1, preferably 1-1.25:1, particularly preferably 1-1.15:1, and
3.5-5 wt-% of Yb₂O₃.

In a preferred and non-limiting embodiment, the sum of the inorganic constituents is 100 wt-%.

In a particularly preferred and non-limiting embodiment, the inorganic raw material mixture according to the disclosure comprises
47.5-51.5 wt-% of Si₃N₄,
45-48 wt-% of a mixture of AlN and Al₂O₃, wherein the ratio of Al₂O₃ to AlN lies in the range of 1-1.5:1, preferably 1-1.25:1, particularly preferably 1-1.2:1, and
3.5-4.5 wt-% of Yb₂O₃.

In a preferred and non-limiting embodiment, the sum of the inorganic constituents is 100 wt-%.

The raw material mixture comprises Yb₂O₃ as sintering aid, which serves to produce high-density ceramics. When using more than 5 wt-% of Yb₂O₃, based on the entire sintered body, the heat resistance, the toughness and the hardness of the sialon sintered body are reduced. In one embodiment, the proportion of Yb₂O₃ with respect to the inorganic raw material mixture according to the disclosure is 0.4-1.5 mol-%, preferably 0.6-1.5 mol-%, and particularly preferably 0.6-1 mol-%.

The sintered body is manufactured from the inorganic raw material mixture according to the disclosure. For this purpose, the inorganic raw material mixture initially is provided. One or more organic adjuvants are added.

The raw materials initially are mixed and/or ground in a solvent. The solvent is water in one embodiment. In another embodiment, the solvent is an organic solvent, a mixture of several organic solvents or a mixture of one or more organic solvents and water. Preferably, the solvent mixtures are single-phase, i.e. the solvents are completely dissolved in each other in the required amounts.

The powdery inorganic raw material mixture should comprise particles with an average particle size of 10 μm or less, preferably 5 μm or less, more preferably 3 μm or less. The inorganic raw material mixture preferably is put into a mixing and grinding machine, such as a ball mill or a Si₃N₄ pot mill, comprising Si₃N₄ grinding balls, and a solvent is added to the material, which does not, at least substantially not, dissolve the powdery raw material. The grain sizes of the raw material mixture are referred to as agglomerates or primary particles, depending on the processing step. The determination of the D50 value of the primary particles, the ground raw materials, is effected by means of centrifugal sedimentation by means of a particle distribution analyzer (DIN EN 725-5:2007, ISO 13320:2020-01).

The mixture then is ground and mixed, until a slurry is obtained and the desired primary grain size, i.e., the grain size of the raw material after grinding and before shaping, has been set. The mixing and grinding process usually takes at least 5 min, preferably 30 min, particularly preferably 1 h to maximally 300 h, preferably maximally 200 h, particularly preferably maximally 100 h.

In one non-limiting embodiment, the Si₃N₄ powder has a primary grain size D50 0.25≤x≤2.5 μm, preferably 0.25≤x≤2.0 μm, particularly preferably D50 0.35≤x≤1.0 μm. The primary grain size influences the shaping and the sintering activity.

In another non-limiting embodiment, the Si₃N₄ has a primary grain size D50 of 1.5≤x≤2.0 μm.

After grinding, further organic adjuvants can also be added, which are mixed with the constituents mentioned above.

The organic adjuvants to be added before or after grinding can be dispersing agents, binders, pressing aids and/or plasticizers. In one non-limiting embodiment, the organic adjuvants are added to the powdery raw material mixture, or the slurry produced in an amount of 1 to 30 wt-%, based on the weight of the inorganic raw material mixture.

The mixture produced, the slurry, comprising the inorganic and organic raw materials in a solvent/solvent mixture in one embodiment are subjected to a granulation by a suitable method, such as spray drying.

Subsequently, the mixture or the granulate is brought into shape. All prior art methods for bringing into shape are applicable. In a preferred and non-limiting embodiment, the granulate is brought into shape by means of pressing, preferably axial pressing, at 50 to 200 MPa. In another embodiment, shaping is effected by means of isostatic pressing.

Shaping can also be effected by applying other methods such as injection molding, extrusion molding or slip casting.

The mixture of the starting materials brought into shape subsequently is debindered and sintered. In a preferred and non-limiting embodiment, sintering is effected under a protective gas, such as nitrogen and/or argon.

Usually, debindering and sintering is effected in a heating device. In one embodiment, the gas atmosphere for debindering and sintering is inert and comprises N₂, argon or a mixture of N₂ and other inert gases, preferably Ar.

Debindering preferably is effected at 400 to 800° C. and preferably takes at least 5 min, preferably 30 min, particularly preferably 1 h to maximally 100 h, preferably maximally 50 h, particularly preferably maximally 30 h.

The exact contents of the individual sialon phase constituents and the proportion and the composition of the amorphous or semi-crystalline grain boundary phase are set by the chosen sintering parameters. When manufacturing the sintered body, when sintering of the inorganic raw material mixture, the sintering aid Yb₂O₃ is converted for instance to Yb—Al garnet, Yb₃Al₅O₁₂, and is enriched in the amorphous or semi-crystalline grain boundary phase. An amount of Yb—Al garnet as low as possible in the grain boundary phase is preferred. The lower the amount of Yb—Al garnet in the grain boundary phase of the sintered body, the higher the wear and abrasion resistance of the sintered body. In a preferred and non-limiting embodiment, a maximum of 1.4 wt-% of Yb—Al garnet is detectable in the grain boundary phase.

The Yb—Al garnet as crystalline fraction stabilizes the grain boundary phase by increasing the softening temperature as compared to a completely amorphous grain boundary phase. In a preferred and non-limiting embodiment, at least 0.02 wt-% of Yb—Al garnet is detectable in the grain boundary phase. The amount of Yb—Al garnet is influenced via the sintering parameters, such as the sintering temperature. At sintering temperatures up to 1950° C. lower proportions of Yb—Al garnet are obtained, at lower sintering temperatures a higher proportion of Yb—Al garnet is obtained (see also Table 2).

Preferably, the proportion of Yb—Al garnet in the sintered body lies between 0.01 and 5 wt-%, particularly preferably between 0.015 and 3 wt-%, in particular preferably between 0.02 and 1.4 wt-%, based on the amount of the crystalline phases in the sintered body.

With a lower sintering temperature, the proportion of crystalline grain boundary phase, and hence also the proportion of Yb—Al garnet in the grain boundary phase, is increased. In addition, too low a sintering temperature leads to a less dense sintered body with increased porosity and consequently also lower abrasion resistance. Preferably, the sintering temperature therefore is more than 1600° C.

Beside the sintering temperature, the cooling rate also has an influence on the proportion of Yb—Al garnet in the amorphous and/or semi-crystalline grain boundary phase. The slower cooling is effected, the higher the proportion of Yb—Al garnet. Preferably, the cooling rate therefore is higher than 1000° C. in 14 h, particularly preferably higher than 1000° C. in 12 h, in particular preferably higher than 1000° C. in 10 h. In one embodiment, the cooling rate is slower than 1000° C. in 4 h; preferably, the cooling rate lies in the range of 1000° C. in 4-8 h.

The sintering temperature not only influences the proportions of the crystalline phases, but also the grain size of the crystallites. The same can be refined in connection with a Rietveld refinement, based on an X-ray diffraction diagram of the sintered body. Table 2 shows the mean grain size of the individual crystalline phases (crystallite size). This refers to the mean length of the congruently scattering domains in the sintered body. For the β-sialon phase it applies: the higher the sintering temperature, the larger the crystallite size of the β-sialon phase. In the sintered body according to the present disclosure, the crystallite size of the Yb—Al garnet phase also is smaller than the mean crystallite size of the sialon phases. Preferably, the crystallite size of the Yb—Al garnet phase is at least 5 times smaller than the mean crystallite size of the sialon phases, particularly preferably the crystallite size of the Yb—Al garnet phase is at least 10 times smaller than the mean crystallite size of the sialon phases.

The mixture of the starting materials brought into shape is sintered at a temperature between 1600° C. and 1950° C., preferably between 1650° C. and 1900° C., particularly preferably between 1750° C. and 1875° C. At these sintering temperatures a sintered body as dense as possible is obtained (>99% of the theoretical density) and the proportion of Yb—Al garnet lies in the preferred range.

In a preferred and non-limiting embodiment, sintering is effected in a gas pressure sintering furnace under a pressure of at least 10 bar, preferably at least 50 bar, particularly preferably at least 75 bar, and preferably maximally 150 bar, particularly preferably maximally 100 bar.

The sintering time preferably is at least 30 min and preferably maximally 3 h, particularly preferably the sintering time is 45 min to 2.5 h.

The finally sintered sialon sintered body subsequently can be removed. Final processing is effected by methods known in the prior art. In one embodiment, the sintered body is processed further by grinding to obtain indexable inserts or solid end mills. The sintered body according to the present disclosure can be processed to obtain a cutting agent that reacts only to a small extent with the workpiece material to be machined, e.g., nickel-base alloys or steels. For machining Ni-based alloys, chemically resistant, hard cutting materials are required. The alloys are highly heat-resistant and hard, very high temperatures are obtained during machining, which in the case of conventional cutting materials leads to reactions and fast wear. When machining nickel-based alloys or Heat Resistant Super Alloys (HRSA) no built-up edge is obtained, i.e. the material of the workpiece to be machined hardly adheres to the cutting agent or not at all. In addition, the high proportion of 15R-sialon polytypoid leads to a chemically very resistant sintered body.

The present disclosure relates to a sintered body on the basis of β-sialon and 15R-sialon, which as cutting material has a high cutting performance as compared to workpieces made of nickel-based alloy or Heat Resistant Super Alloys (HRSA). For this purpose a ceramic sintered body is shown, which includes a sialon phase and an amorphous or semi-crystalline grain boundary phase. The sialon phase includes a proportion of 20-80 wt-% of 15R-sialon polytypoid. The amorphous or semi-crystalline grain boundary phase possibly comprises an Yb—Al garnet and constitutes up to 15 wt-% of the entire sintered body.

The Yb₂O₃ from the raw material mixture, beside the Al-based additives and the SiO₂ contained in the Si₃N₄ raw material, serves as sintering aid. While the Al-based additives and the SiO₂ can also be incorporated into the crystal lattice of the described sialon phases during the sintering process, the Yb remains in the grain boundary phase of the sintered body. As a result, and due to the content of Yb, the properties of the grain boundary phase such as the glass transformation point and the binding of the sialon phases with the grain boundary phase are influenced. This binding determines the dominating mechanisms during the crack propagation in the sintered body and thereby is decisive for the fracture toughness of the sintered body. Therefore, the grain boundary phase of the sintered body according to the present disclosure contains at least 1.5 wt-%, preferably 2 wt-%, particularly preferably 2.5 wt-% and maximally 5 wt-% of Yb, calculated in the form of the sesquioxide Yb₂O₃ and with respect to the total weight of the sintered body.

The sintered body is manufactured from an inorganic raw material mixture which comprises 40 to 57 wt-% of Si₃N₄; 40 to 55 wt-% of a mixture of AlN and Al₂O₃, wherein the ratio of Al₂O₃ to AlN lies in the range of 1-1.5:1, and 3 to 5 wt-% of Yb₂O₃ as sintering aid.

### Exemplary Embodiments

The following inorganic raw material mixtures (RMM) were provided for the synthesis of sintered bodies.

TABLE 1
Composition of the inorganic raw material mixture

| | [wt-%] | | | | |
|---|---|---|---|---|---|
| | Si₃N₄ | Al₂O₃ | AlN | Yb₂O₃ ([mol %]) | Y₂O₃ ([mol %]) |
| RMM SdT | 48.8 | 24.1 | 23.1 | — | 4.0 (1.5) |
| RMM 1 | 48.8 | 24.1 | 23.1 | 4.0 (0.9) | — |
| RMM 3 | 51.9 | 25.5 | 18.3 | 4.2 (1.0) | — |
| RMM 4 | 50.1 | 24.6 | 21.1 | 4.1 (0.9) | — |

The starting materials, see Table 1, were mixed. Si₃N₄ with an α-Si₃N₄ content of >95%, a mean grain diameter of >0.45 μm and an oxygen content of 1.2-1.4 wt-% as well as Yb₂O₃ with a purity >99.9%, a mean grain diameter of about 5 μm, Al₂O₃ with a purity >99.9%, a mean grain diameter of 0.3 μm and AlN with an oxygen content of 0.6-1% and an average grain diameter of 1.2-1.7 μm are weighed, mixed with water and ground for at least 30 min in an agitator bead mill. Subsequently, the addition of the organic components is effected. The ceramic slip (slurry) thus obtained is granulated by means of spray drying. Molded bodies were axially pressed at a pressing pressure of about 1000 bar and debindered for 2 h at 500° C. The subsequent sintering was effected according to the parameters from Table 2.

The sintered molded bodies were ground to obtain cutting plates.

TABLE 2
Composition and properties of the sintered bodies

| | Sintering | Retention | | Crystallite | | Crystallite | Yb—Al | Crystallite | | K_{jc} | Suit- |
|---|---|---|---|---|---|---|---|---|---|---|---|
| | temperature | time | 15R* | Size** 15R | β-sialon* | Size** β- | garnet* | Size** Yb—Al | Hardness | [MPa * | abil- |
| | [° C.] | [h] | [wt-%] | [nm] | [wt-%] | sialon [nm] | [wt-%] | garnet [nm] | [GPa] | m\hat{ }0.5] | ity*** |
| RMM 1 | 1650 | 1 | 50.68 | 252.3 | 45.44 | 100.3 | 3.88 | 40.4 | 15.1 | 4.9 | + |
| | 1800 | 1 | 44.47 | 91.8 | 54.39 | 115.4 | 1.14 | 3.1 | 14.7 | 5.1 | +++ |
| | 1850 | 1 | 44.93 | 112.0 | 53.86 | 189.6 | 1.21 | 2.9 | 14.7 | 4.8 | +++ |
| | 1875 | 1 | 57.62 | 200.2 | 42.36 | 1839.0 | 0.02 | 32.9 | not | not | +++ |
| | | | | | | | | | determined | determined | |
| RMM 4 | 1850 | 1 | 24.92 | 107.3 | 75.03 | 288.3 | 0.06 | 26.1 | not | not | ++ |
| | | | | | | | | | determined | determined | |
| RMM 3 | 1850 | 1 | 16.37 | 235.0 | 82.19 | 313.3 | 1.44 | 2.8 | not | not | + |
| | | | | | | | | | determined | determined | |

*the indication refers to the proportion of crystalline phases and was determined by means of Rietveld refinement, Topas version 4.2, cif-files 00-048-1616, 00-042-0160, 00-023-1476
**the indication refers to the result of the Rietveld refinement carried out for determining the crystalline phases (see*), the crystallite size was refined according to Gauss
***results from experiments for machining nickel-based alloys (Inconel 718)

The determination of the measurement values was effected according to the following standard specifications: RFA: DIN 51001 (2003 August), DIN 51418-1 (2010 May), DIN 51418-2 (2015 March); XRD: DIN EN 13925-1 (2003 July), DIN 13925-2 (2003 July); density: DIN EN 623-2 (1993-11), ISO 18754 (2020 April); hardness: DIN EN 843-3 (2005 August), ISO 14705 (2016 December), ASTM C 1327 (2015); fracture toughness: ISO 14627 (2012 July)

1. An inorganic raw material mixture, comprising:
40-57 wt-% of Si₃N₄
40-55 wt-% of a mixture of AlN and Al₂O₃, wherein the ratio of Al₂O₃ to AlN is from of 1-1.5:1, and
3-5 wt-% of Yb₂O₃, wherein the sum of the inorganic constituents is 100 wt-%.

2. The raw material mixture according to claim 1, wherein the ratio of Al₂O₃ to AlN is 1-1.25:1.

3. The raw material mixture according to claim 1, comprising
45-54.5 wt-% of Si₃N₄,
42-50 wt-% of a mixture of AlN and Al₂O₃, and
3.5-5 wt-% of Yb₂O₃.

4. The raw material mixture according to claim 1, comprising
47.5-51.5 wt-% of Si₃N₄,
45-48 wt-% of a mixture of AlN and Al₂O₃, and
3.5-4.5 wt-% of Yb₂O₃.

5. The raw material mixture according to claim 1, wherein the Si₃N₄ powder has a primary grain size D50 0.25≤x≤2.5 μm.

6. A ceramic sintered body comprising
a sialon phase comprising β-sialon and 15R-sialon, wherein the proportion of 15R-sialon polytypoid is 20-80 wt % of the sialon phase, and an amorphous or semi-crystalline grain boundary phase, wherein the grain boundary phase constitutes up to 15 wt-% of the entire sintered body, wherein the grain boundary phase comprises maximally 5 wt-% of Yb, calculated in the form of the sesquioxide Yb₂O₃ and with respect to the total weight of the sintered body.

7. The ceramic sintered body according to claim 6, wherein the grain boundary phase comprises at least 1.5 wt-% of Yb, calculated in the form of the sesquioxide Yb₂O₃ and with respect to the total weight of the sintered body.

8. The ceramic sintered body according to claim 6, wherein the proportion of 15R-sialon polytypoid is 30-70 wt-%, based on the total weight of the sialon phase.

9. The ceramic sintered body according to claim 8, wherein the sialon phase further comprises up to 10 wt-% of 12H-, 21R-, 27R- or α-sialon.

10. The ceramic sintered body according to claim 6, wherein the proportion of Yb—Al garnet in the sintered body is from 0.01 to 5 wt-%, based on the amount of the crystalline phases in the sintered body.

11. The ceramic sintered body according to claim 6, wherein the crystallite size of the Yb—Al garnet phase is smaller than the mean crystallite size of the sialon phases.

12. A method for manufacturing the sintered body according to claim 6, comprising the method steps:
(a) providing a raw material mixture comprising:
40-57 wt-% of Si₃N₄
40-55 wt-% of a mixture of AlN and Al2O3, wherein the ratio of Al2O3 to AlN is from of 1-1.5:1, and
3-5 wt-% of Yb2O3, wherein the sum of the inorganic constituents is 100 wt-%
(b) adding one or more organic adjuvants
(c) mixing and grinding the raw materials, optionally in at least one liquid selected from water and/or at least one organic solvent and/or addition of one or more further organic adjuvants
(d) bringing the mixture into shape
(e) debindering and sintering the mixture, and
removing the sintered body.

13. The method according to claim 12, wherein sintering in method step (e) is carried out at 1600° C. to 1950° C.

14. The method according to claim 12, wherein the gas atmosphere is selected from N₂ and/or a protective gas.

15. (canceled)

16. The method according to claim 12, wherein the gas atmosphere comprises N₂.

17. The method according to claim 12, wherein the sintering takes place at a pressure of 10-100 bar.

18. The ceramic sintered body according to claim 6, wherein the proportion of 15R-sialon polytypoid is 40-60 wt-%, based on the total weight of the sialon phase.

19. The ceramic sintered body according to claim 8, wherein the sialon phase further comprises up to 5 wt-% of 12H-, 21R-, 27R- or α-sialon.
